(19) United States
(12) Patent Application Publication
(10) Pub. No.: US 2024/0018861 A1
(43) Pub. Date: Jan. 18, 2024

(54) REID VAPOR PRESSURE CONTROL SYSTEM

(71) Applicant: NATIONAL OILWELL VARCO, L.P., Houston, TX (US)

(72) Inventor: Spencer Thomas Oulman, Houston, TX (US)

(21) Appl. No.: 17/812,049

(22) Filed: Jul. 12, 2022

(51) Int. Cl. E21B 43/34; G01F 1/74; G01F 15/08

(52) U.S. Cl. CPC E21B 43/34; G01F 1/74; G01F 15/08

(57) ABSTRACT

A Reid vapor pressure control system includes a separator vessel that receives a multiphase flow stream having a gas phase, an oil phase, and a water phase. The Reid vapor pressure control system further includes a gas phase output meter and one or more liquid phase output meters operably connected to a process controller. The process controller is configured to determine an energy input rate used to reduce the Reid vapor pressure of the oil phase based on the operating parameters of the Reid vapor pressure control system during a disturbance test. During operation, the process controller supplies input energy at the energy input rate to the Reid vapor pressure control system.

### TECHNOLOGICAL FIELD

The present disclosure generally relates to production of crude oil and, more particularly, to the processing crude oil prior to transportation or storage.

### BACKGROUND

Hydrocarbon vapors given off by crude oil are flammable and in particular vapor to air ratios can explosively ignite. Furthermore, these vapors are a pollutant that is controlled and regulated. These characteristics of crude oil have led to industry and governmental requirements that establish thresholds for a maximum vapor pressure of crude oil being transported or stored. Accordingly, systems to reduce and/or control the vapor pressure of crude oil prior to transportation and storage are desirable.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a process and instrumentation diagram of a Reid vapor pressure control system in accordance with some examples.

FIG. 1B is a process and instrumentation diagram of a Reid vapor pressure control system with auxiliary components in accordance with some examples.

FIG. 2 is an illustration of a relationship between a gas flowrate and a sensible heat flux versus an energy input rate in a Reid vapor pressure control system in accordance with some examples.

FIG. 3A is an illustration of a response of a Reid vapor pressure control system during a pulsed system disturbance test process while the Reid vapor pressure control system is in an operational energy input regime in accordance with some examples.

FIG. 3B is another illustration of a response of a Reid vapor pressure control system during a pulsed system disturbance test process while the Reid vapor pressure control system is in another operational energy input regime in accordance with some examples.

FIG. 3C is another illustration of a response of a Reid vapor pressure control system during a pulsed system disturbance test process while the Reid vapor pressure control system is in another operational energy input regime in accordance with some examples.

FIG. 4 is an activity diagram of an energy input rate determination process for a Reid vapor pressure control system in accordance with some examples.

FIG. 5 is an activity diagram of a system disturbance test process performed by a process controller of a Reid vapor pressure control system in accordance with some examples.

FIG. 6 is an activity diagram of an operating parameters determination process of a Reid vapor pressure control system in accordance with some examples.

FIG. 7 is an activity diagram of a Reid vapor pressure control system Reid vapor pressure reduction process in accordance with some examples.

FIG. 8 is a diagrammatic representation of a machine, in a form of a computing apparatus within which a set of instructions may be executed for causing the machine to perform any one or more of the methodologies discussed herein in accordance with some examples.

### DETAILED DESCRIPTION

Crude oil produced from an oil reservoir is a mixture of hydrocarbons of various carbon chain lengths and degrees of saturation (hydrogen to carbon ratio). As crude oil is a mixture of hydrocarbons each of which has its own vapor pressure curve it is difficult to determine an accurate vapor pressure curve versus temperature for a crude oil; accordingly, methods of experimentally determining a vapor pressure of a crude oil at a given temperature, known as the Reid vapor pressure, have been developed.

It can be important to control Reid vapor pressure for transportation, storage, and sale of crude oil and shale gas liquids. When the Reid vapor pressure of crude oil is too high, excessive breakout of volatile gas during operations can occur. A common control method is input energy into the crude oil to drive off volatile materials. However, lowering Reid vapor pressure values lower than desired can produce excessive quantities of low-pressure resulting in flaring, leakage, or added work to recompress and send the gas along with sales gas streams.

In some examples, a Reid vapor pressure control system includes a separator vessel and an energy input device, a gas flowrate sensor, one or more liquid flowrate sensors, and one OF more liquid flow temperature sensors operably connected to the separator vessel. The Reid vapor pressure control system also includes a process controller operably connected to the energy input device, the gas flowrate sensor, the one or more liquid flowrate sensors, and the one or more liquid flow temperature sensors. The process controller determines an energy input rate to reduce a Reid vapor pressure of an oil phase of a multiphase flow stream being processed by the Reid vapor pressure control system in the separator vessel using the gas flowrate sensor, the one or more liquid flowrate sensors, and the one or more liquid flow temperature sensors of the Reid vapor pressure control system, and controls the energy input device to input energy into the separator vessel at the energy input rate.

In some examples, the process controller determines the energy input rate by performing a system disturbance test of the Reid vapor pressure control system, determining operating parameters of the Reid vapor pressure control system during the system disturbance test using the gas flowrate sensor, the one or more liquid flowrate sensors, and the one or more liquid flow temperature sensors, and determining the energy input rate based on the operating parameters of the Reid vapor pressure control system.

In some examples, the process controller determines the energy input rate based in part on an energy flux sensor, such as a heat flux sensor, to determine an amount of energy loss of the separator vessel to the surrounding environment.

In some examples, the one or more liquid flowrate sensors include an oil flowrate sensor and a water flowrate sensor.

In some examples, the process controller performs the system disturbance test of the Reid vapor pressure control system by determining operating parameters of the Reid vapor pressure control system at a baseline energy input rate during a baseline energy input rate period using the gas flowrate sensor, the one or more liquid flowrate sensors, and the one or more liquid flow temperature sensors, incrementing an energy input rate to an incremented energy input rate, and determining operating parameters of the Reid vapor pressure control system at the incremented energy input rate for an incremented energy input rate period using the gas flowrate sensor, the one or more liquid flowrate sensors, and the one or more liquid flow temperature sensors.

In some examples, the process controller, while performing the system disturbance test of the Reid vapor pressure control system, decrements the energy input rate to a decremented energy input rate, and determines operating parameters of the Reid vapor pressure control system at the decremented energy input rate for a decremented energy input rate period using the gas flowrate sensor, the one or more liquid flowrate sensors, and the one or more liquid flow temperature sensors.

In some examples, the process controller, while determining the energy input rate, determines a change in an energy flux, such as a sensible heat flux of the Reid vapor pressure control system using the one or more liquid flowrate sensors, the one or more liquid flow temperature sensors, and the gas flowrate sensor, determines a change in a gas flowrate of a gas phase of the multiphase flow stream using the gas flowrate sensor, and determines an energy input regime of the Reid vapor pressure control system based on the change in the sensible heat flux and the change in the gas flowrate of the gas phase of the multiphase flow stream.

Accordingly, a Reid vapor pressure control system may allow operators to reduce the number of traditional Reid vapor pressure samples analyzed, gain assurance of running within specification, and assure that no energy is wasted.

Other technical features may be readily apparent to one skilled in the art from the following figures, descriptions, and claims.

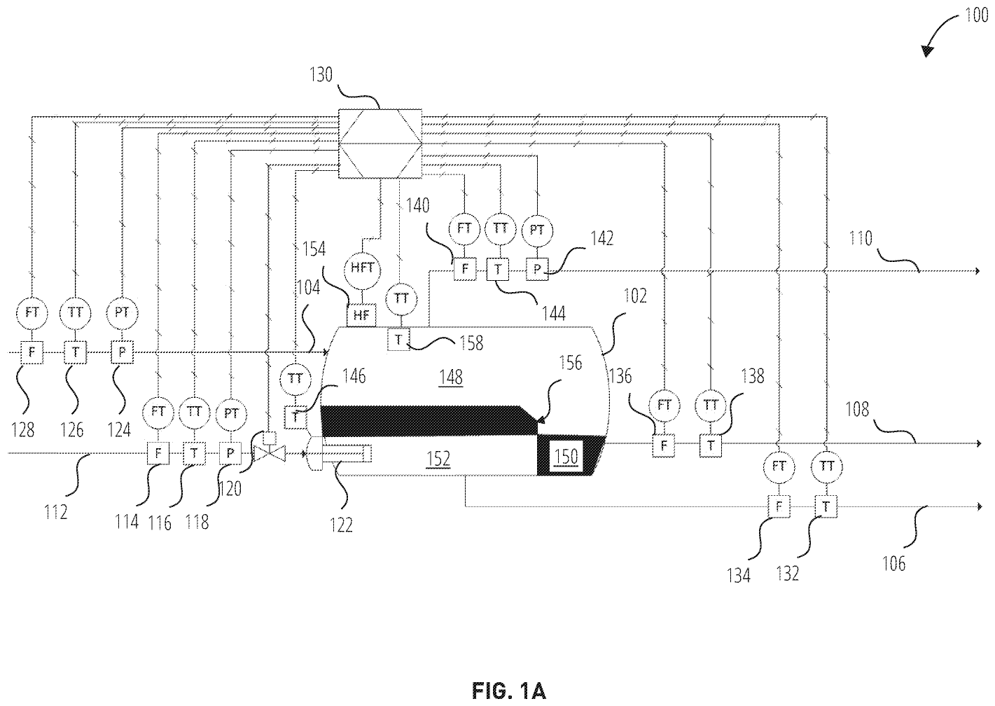

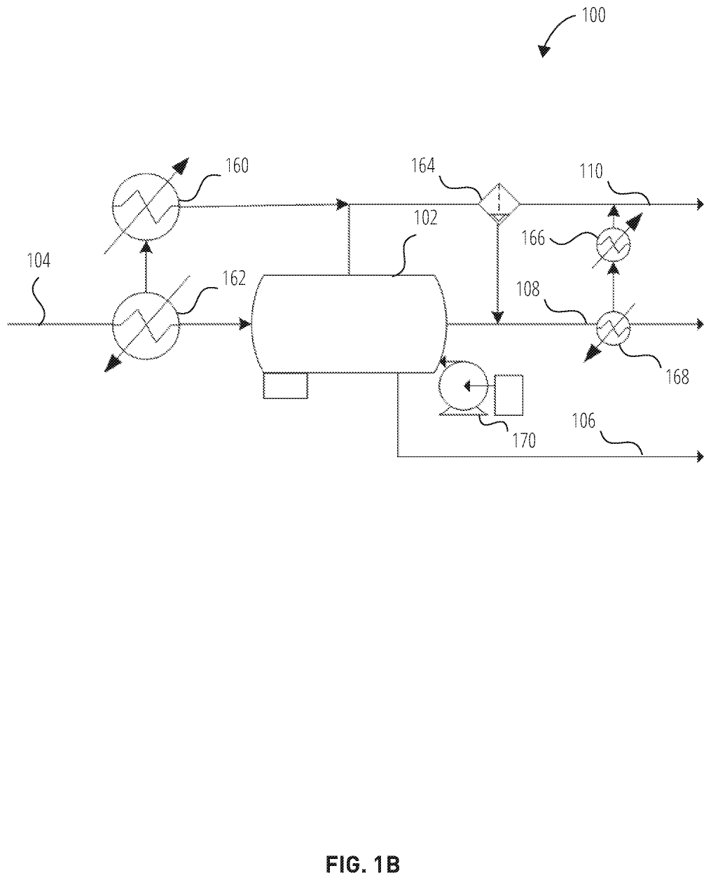

FIG. 1A is a process and instrumentation diagram of a Reid vapor pressure control system 100 in accordance with some examples. The Reid vapor pressure control system 100 is used to lower a Reid vapor pressure of crude oil in a multiphase flow stream having crude oil, produced water, and produced gas from an oil well. The Reid vapor pressure control system 100 inputs energy into the multiphase flow stream to separate the multiphase flow stream into oil, water, and gas phases into separate flow streams. During the energy input and separating process, the Reid vapor pressure of the oil phase is reduced.

The Reid vapor pressure control system 100 incudes a separator vessel 102. The separator vessel 102 included an internal weir 156 that facilitates separation of an oil phase 150 from a water phase 152 inside of the separator vessel 102. In some examples, the separator vessel 102 is a heater treater that conditions the multiphase flow stream using heat. In some examples, the separator vessel 102 is a two-phase separator that separates oil and water from free gas in the multiphase flow stream. In some examples, the separator vessel 102 is a three-phase separator that separates oil, water, and gas in the multiphase flow stream.

The separator vessel 102 is operably connected to an inlet flowline 104 at an inlet. The inlet flowline 104 supplies a multiphase flow stream of mixed crude oil, water, and gas to the separator vessel 102. The multiphase flow stream enters the separator vessel 102 and the separator vessel 102 separates the multiphase flow stream into separate flow streams. In some examples, the separator vessel 102 separates the multiphase flow stream into a gas phase 148, an oil phase 150, and a water phase 152. In some examples, the separator vessel 102 is a two-phase separator that separates the multiphase flow stream into a gas phase 148, and a combined oil and water phase (not shown).

The separator vessel 102 provides for separate output flowlines for each separated phase. The separator vessel 102 is operably connected to a gas output flowline 110 that exits the separator vessel 102 and carries gas that has been separated from the multiphase flow stream out of the separator vessel 102. In some examples, the separator vessel 102 is a three-phase separator and is further operably connected to a water flowline 106 exiting the separator vessel 102 that carries water that has been separated out of the multiphase flow stream. The separator vessel 102 is further operably connected to an oil output flowline 108 exiting the separator vessel 102 that carries oil that has been separated out of the multiphase flow stream. In some examples, the separator vessel 102 is a two-phase separator operably connected to a combined oil and water phase flowline (not shown) that carries a combined oil and water phase out of the separator vessel 102.

The Reid vapor pressure control system 100 includes an energy input device, such as a gas-fired energy input device 122, in the separator vessel 102 that is operable to input energy into one or more fluids of a multiphase flow stream flowing into the Reid vapor pressure control system 100. The energy input into the one or more fluids is converted into sensible heat that increases a temperature of the one or more fluids, or it may be converted into latent heat by vaporization of the components of the oil phase or by separation and expansion of gases entrained or dissolved in the one or more fluids,

The separator vessel 102, the inlet flowline 104, the oil output flowline 108, and the gas output flowline 110 include a variety of instrumentation used to measure parameters of the Reid vapor pressure control system such as, but not limited to, an energy flux from an outer surface of the separator vessel 102, an energy flux of a wall of the energy input device 122, a temperature of the separator vessel 102 and a temperature, pressure, and flowrate of the fluids flowing through separator vessel 102.

The instrumentation of the Reid vapor pressure control system 100 includes a separator vessel energy flux sensor 154 that senses a heat flux parameter of an outer surface of the separator vessel 102 and a separator vessel temperature sensor 158 that senses an internal temperature of the separator vessel 102.

The instrumentation of the Reid vapor pressure control system 100 further includes a multiphase flow stream flowrate sensor 128 operably connected to the inlet flowline 104 that may be used to measure a flowrate of a multiphase flow stream flowing into the separator vessel 102. The Reid vapor pressure control system 100 also includes a multiphase flow stream temperature sensor 126 operably connected to the inlet flowline 104 that senses a temperature of the multiphase flow stream. A multiphase flow stream pressure sensor 124 operably connected to the inlet flowline 104 may also be provided that senses a pressure of the multiphase flow stream flowing in the inlet flowline 104.

The instrumentation of the Reid vapor pressure control system 100 further includes a gas flowrate sensor 140 operably connected to the gas output flowline 110 that senses a flowrate of the gas flowing in the gas output flowline 110, a gas flow temperature sensor 144 operably connected to the gas output flowline 110 that senses a temperature of the gas flowing in the gas output flowline 110, and a gas flow pressure sensor 142 operably connected to the gas output flowline 110 that senses the pressure of the gas flowing in the gas output flowline 110.

The instrumentation of the Reid vapor pressure control system 100 further includes a liquid water flowrate sensor 134 operably connected to the water flowline 106 and a liquid water flow temperature sensor 132 operably connected to the water flowline 106 that measure a flowrate and a temperature, respectively, of the water phase flowing out of the separator vessel 102.

The instrumentation of the Reid vapor pressure control system 100 further includes a liquid oil flowrate sensor 136 and a liquid oil flow temperature sensor 138 operably connected to the oil output flowline 108 that measure a flowrate and a temperature, respectively, of the oil phase that is flowing out of the separator vessel 102.

The Reid vapor pressure control system 100 further includes a process controller 130 that is operably connected to the instrumentation of the Reid vapor pressure control system 100, including the multiphase flow stream flowrate sensor 128, the multiphase flow stream temperature sensor 126, the multiphase flow stream pressure sensor 124, the separator vessel energy flux sensor 154, the separator vessel temperature sensor 158, the gas flowrate sensor 140, the gas flow temperature sensor 144, the gas flow pressure sensor 142, the oil flowrate sensor 136, the oil flow temperature sensor 138, the water flowrate sensor 134, and the water flow temperature sensor 132.

In some examples, energy input device 122 is a gas-operated heater operably connected to a gas feed flowline 112 that supplies a flammable gas to the energy input device 122. In some such examples, the instrumentation of the Reid vapor pressure control system 100 further includes a wall temperature sensor 146 that senses a temperature of a wall of the gas-fired energy input device 122, a gas feed flowrate sensor 114, a gas feed temperature sensor 116, and a gas feed pressure sensor 118 each operably connected to a gas feed flowline 112 that respectively measure a flowrate, temperature, and pressure of a flammable gas supplied to the energy input device 122. The process controller 130 is further operably connected to the gas feed flowrate sensor 114, the gas feed temperature sensor 116, and the gas feed pressure sensor 118, and a gas feed valve controller 120 that controls the amount of flammable gas fed to the energy input device 122

In some examples, the energy input device 122 is powered by electrical energy, such as a microwave heater, an induction heater, an electrical resistance heater, a mechanical agitator, a sonic heater, or the like. In some such examples, the instrumentation of the Reid vapor pressure control system 100 further includes an energy meter (not shown), such as a wattmeter, that senses the power used by the energy input device 122 and an electrical power controller that controls an amount of power supplied to the energy input device 122. The process controller 130 is further operably connected to the energy meter and the electrical power controller.

In some examples, the Reid vapor pressure control system 100 includes a water level control subsystem used to control a water level in the separator vessel 102. The water level subsystem includes a water level senor that senses a level of the water phase 152 and a control valve operably connected to the water level sensor located on the water flowline 106 for control ling the outflow of the water phase from the separator vessel 102.

In some examples, the Reid vapor pressure control system 100 includes an oil level control subsystem used to control oil level in the separator vessel 102. The water level subsystem includes an oil level senor that senses a level of the oil phase 150 and a control valve operably connected to the oil level sensor located on the oil output flowline 108 for controlling the outflow of the oil phase from the separator vessel 102.

In some examples, the Reid vapor pressure control system 100 includes a back pressure control subsystem used to control gas pressure in the separator vessel 102. A back pressure control subsystem may include a pressure senor that senses a pressure in the separator vessel 102 and a control valve operably connected to the pressure sensor located on the gas output flowline 110 for controlling the outflow of the gas phase from the separator vessel 102,

In some examples, the instrumentation of the Reid vapor pressure control system 100 further includes a surface temperature sensor on an outer surface of the separator vessel 102 and an ambient temperature sensor. The process controller 130 uses the surface temperature sensor and the ambient temperature sensor to determine convective and radiative energy fluxes, such as heat fluxes, from the separator vessel 102, either in conjunction with or in lieu of, the separator vessel energy flux sensor 154.

In some examples, the separator vessel 102 operates on principles of gravity to separate the oil, water, and gas in the multiphase flow stream. In some examples, the separator vessel 102 is a cyclone or centrifugal separator that operates on principles of centrifugal force to separate the oil, water, and gas in the multiphase flow stream.

In some examples, the Reid vapor pressure control system 100 includes a water cut sensor on the oil output flowline 108 that is used to measure a fraction of water that is in the oil phase flowing out of the separator vessel 102.

In some examples, the Reid vapor pressure control system 100 operates as an emulsion breaker by adding additional input energy to separate an emulsion of produced water and crude oil.

FIG. 1B is a process and instrumentation diagram of a Reid vapor pressure control system with auxiliary components in accordance with some examples.

In some examples, a Reid vapor pressure control system 100 includes an auxiliary heater separator 162 connected to an inlet flowline 104 that can be used to pretreat a multiphase flow stream flowing into a separator vessel 102 and separate some of the gases from the multiphase flow stream. The auxiliary heater separator 162 is connected to a condenser 160, knockout pot, or the like to separate liquids entrained in a gas stream separated from the multiphase flow stream.

In some examples, a Reid vapor pressure control system 100 includes an auxiliary heater separator 168 connected to an oil output flowline 108 that can be used to condition an oil phase flowing out of the separator vessel 102 and separate additional gases from the oil phase. The auxiliary heater separator 168 is connected to a condenser 166, knockout pot, or the like to separate liquids entrained in a gas stream separated from the oil phase.

In some examples, a Reid vapor pressure control system 100 includes a demister 164, knockout pot, or the like, in a gas output flowline 110 of the Reid vapor pressure control system 100. The demister 164 separates liquids entrained in a gas phase exiting the separator vessel 102.

In some examples, a Reid vapor pressure control system 100 includes a chemical treatment system 170. The chemical treatment system 170 injects chemicals into the separator vessel 102 that assist in the separation of oil, water, and gas phases of a multiphase flow stream flowing into the separator vessel 102.

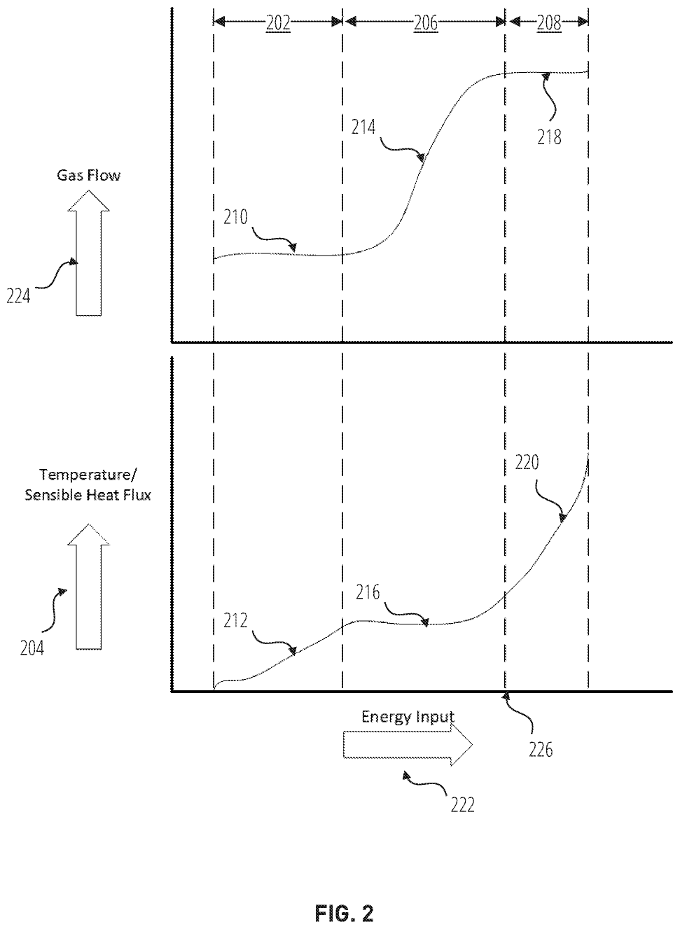

FIG. 2 is an illustration of a relationship between a gas flowrate, a temperature or sensible heat flux, and energy input rate in a Reid vapor pressure control system 100 in accordance with some examples. The illustration includes a graph of a gas flowrate 224 of a gas phase exiting the Reid vapor pressure control system 100, an energy flux, such as a sensible heat flux 204, of an amount of energy flowing through the Reid vapor pressure control system 100, and an energy input rate 222 into the Reid vapor pressure control system 100 by the energy input device 122. The sensible heat flux 204 is a measure of an amount of energy measurable as sensible heat flowing through the Reid vapor pressure control system 100. In some examples, the sensible heat flux can be determined based on a specific heat of the fluid phases flowing through the Reid vapor pressure control system 100, a mass flow rate of the fluid phases, and a measurement of the energy flux from the separator vessel 102 to the surrounding environment.

During energy input, gases that are entrained in the oil phase are driven out of the oil phase through a process of vaporization, degasification, and expansion of the gases. Vaporization and degasification of the oil phase and expansion of the resultant gases utilizes energy in the form of latent heat that is converted to work and is no longer sensible within the Reid vapor pressure control system 100. In addition, lighter hydrocarbons of the oil phase are vaporized and transition from a liquid phase to a gas phase. The energy in the form of latent heat utilized to vaporize the lighter hydrocarbons is no longer sensible within the Reid vapor pressure control system 100 through temperature measurements. Accordingly, when monitoring the Reid vapor pressure control system 100, a temperature and a gas flowrate of the system during an energy input process will exhibit a characteristic behavior indicating the energy flux of the system, that is input energy is either converted into sensible heat that raises the temperature of the Reid vapor pressure control system or into latent heat used for vaporization, degasification, and expansion of the gases and vapors that are being removed from the oil phase resulting in increased gas flow from the Reid vapor pressure control system 100 without a concurrent increase in the temperature of the Reid vapor pressure control system 100.

During an input of energy, while in energy input regime A 202, a temperature 212 of the Reid vapor pressure control system 100 is too low to drive off entrained gases and vaporize liquid hydrocarbons from the oil phase. Instead, energy input into the Reid vapor pressure control system 100 contributes to the sensible heat of the Reid vapor pressure control system 100 and may be detected by a rise in the temperature 212 of the Reid vapor pressure control system 100. In addition, the gas flowrate 210 in energy input regime A 202 shows little additional entrained gas is driven off and little additional hydrocarbons are vaporized from the oil phase. That is, a first derivative, dQs/dQi, of the sensible heat of the Reid vapor pressure control system 100. Qs, versus energy input rate. Qi, is positive and a first derivative, dFg/dQi, of the gas flow rate, Fg, is approximately equal to zero.

In an energy input regime B 206, the temperature of the multiphase flow stream is high enough that energy input into the Reid vapor pressure control system 100 contributes to latent heat driving off entrained gas and vaporization of hydrocarbons from the oil phase causing a gas flowrate 214 to increase and contributes little to the sensible heat detected by a temperature 216 of the Reid vapor pressure control system 100. That is, dQs/dQi is approximately equal to zero and dFg/dQ is positive.

In an energy input regime C 208, the temperature 220 of the multiphase flow stream is high enough that a gas flowrate 218 in energy input regime C 208 indicates that little additional gas is being added to the gas flowrate. That is, dQs/dQi is positive and dFg/dQ is approximately equal to zero.

At a desirable energy input rate 326, enough energy is input into the Reid vapor pressure control system 100 to drive off entrained gases and vaporize lighter hydrocarbons from the oil phase 150 to reduce the Reid vapor pressure of the oil phase 150 while not providing excessive energy that is wasted by not contributing to additional gases and light hydrocarbons being removed from the oil phase 150.

The Reid vapor pressure control system 100 parameter characteristics during energy input are used to determine sensible heat flux at an incremented and a decremented energy input rate for the Reid vapor pressure control system 100 using a pulsed system disturbance test process. During a pulsed system disturbance test, a baseline energy input rate is incremented in a discrete step above the baseline energy input rate and a response of the Reid vapor pressure control system 100 is determined by measuring the process parameters of the Reid vapor pressure control system 100 at the incremented energy input rate. The energy input rate is then decremented to below the baseline energy input rate and a response of the Reid vapor pressure control system 100 is again determined by measuring the process parameters of the Reid vapor pressure control system 100 at the decremented energy input rate.

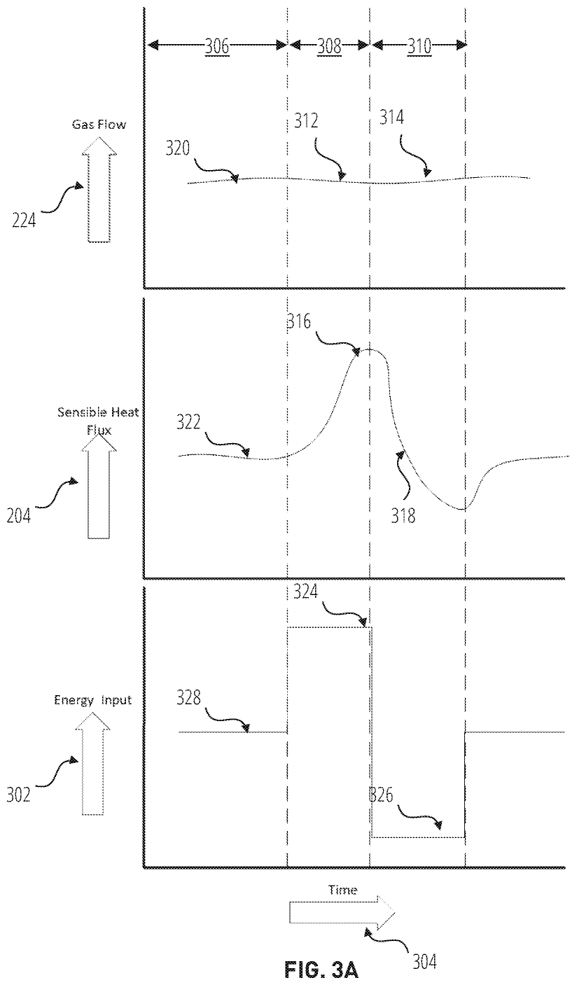

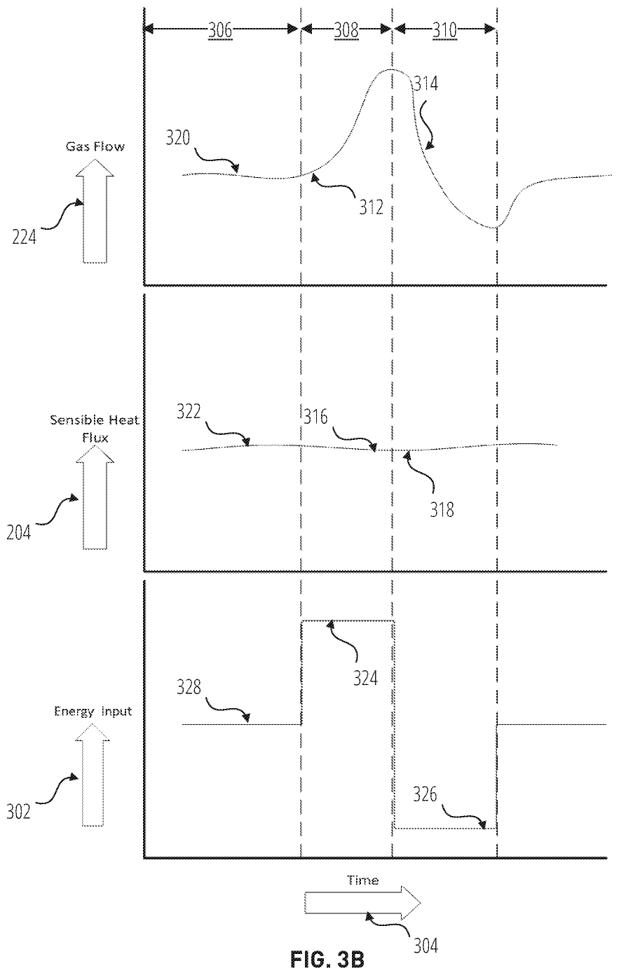

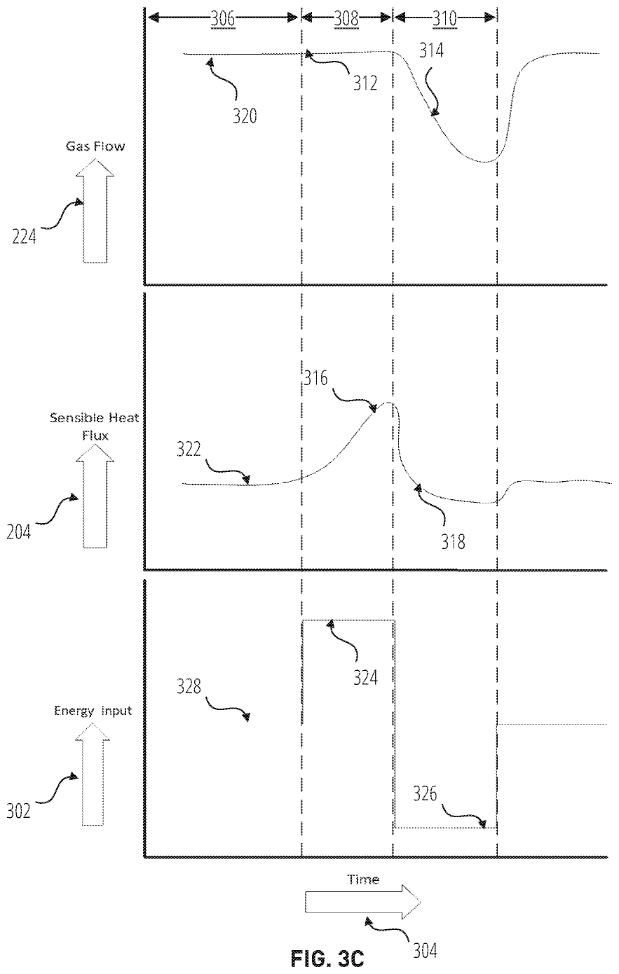

FIG. 3A is an illustration of a response of a Reid vapor pressure control system 100 during a pulsed system disturbance test process while the Reid vapor pressure control system 100 is in an energy input regime A 202 in accordance with some examples. The illustration includes a graph of a gas flowrate 224 of a gas phase exiting the Reid vapor pressure control system 100, a sensible heat flux 204 of the amount of sensible heat flowing through the Reid vapor pressure control system 100, and an energy input rate 302 of an amount of energy being introduced into Reid vapor pressure control system 100 by the energy input device 122, versus elapsed time 304 for a pulsed energy input rate.

During a baseline energy input rate period 306, a process controller 130 holds a baseline energy input rate 328 at a known baseline energy input rate. The Reid vapor pressure control system exhibits a baseline sensible heat flux 322 and baseline gas flowrate 320 through the Reid vapor pressure control system 100.

During an incremented energy input rate period 308, the process controller 130 increments the energy input rate to a known incremented energy input rate 324. The Reid vapor pressure control system will exhibit a sensible heat flux at the incremented energy input rate 316 and a gas flowrate at the incremented energy input rate 312. As the Reid vapor pressure control system is in energy input regime A 202, the sensible heat flux at the incremented energy input rate 316 will show a correlation with the incremented energy input rate 324 as the energy input contributes to the sensible heat flux through the Reid vapor pressure control system. The gas flowrate at the incremented energy input rate 312 will not show a response as the temperature of the Reid vapor pressure control system will be too low for the additional energy input to cause additional gas to be driven off or additional lighter hydrocarbons to be vaporized from the oil phase.

During a decremented energy input rate period 310, the process controller 130 decrements the energy input rate to a known decremented energy input rate 326 below the baseline energy input rate 328. As the Reid vapor pressure control system is in energy input regime A 202, the sensible heat flux at the decremented energy input rate 318 will show a correlation with the decremented energy input rate 326 as the reduced energy input contributes to a drop in the sensible heat flux through the Reid vapor pressure control system. The gas flowrate at the decremented energy input rate 314 will not show a correlated response as the temperature of the Reid vapor pressure control system is already too low for the reduced energy input to cause even less gas to be driven off or even less lighter hydrocarbons to be vaporized from the oil phase.

FIG. 3B is an illustration of a response of a Reid vapor pressure control system 100 during a pulsed system disturbance test process while the Reid vapor pressure control system 100 is in an energy input regime B 206 in accordance with some examples. The illustration includes a graph of a gas flowrate 224, a sensible heat flux 204, and an energy input rate 302 versus elapsed time 304 for a pulsed energy input rate.

During a baseline energy input rate period 306, the process controller 130 holds energy input into the Reid vapor pressure control system at a known baseline energy input rate 328. At the baseline energy input rate 328, the Reid vapor pressure control system exhibits a baseline sensible heat flux 322 and baseline gas flowrate 320 through the Reid vapor pressure control system.

During an incremented energy input rate period 308, the process controller 130 increments the energy input rate to an incremented energy input rate 324. The Reid vapor pressure control system will exhibit a sensible heat flux at the incremented energy input rate 316 and a gas flowrate at the incremented energy input rate 312. As the Reid vapor pressure control system is in energy input regime B 206, the sensible heat flux at the incremented energy input rate 316 will not show a correlated response with the incremented energy input rate 324 as any additional energy input does not contribute to the sensible heat flux through the Reid vapor pressure control system. The gas flowrate at the incremented energy input rate 312 will exhibit a correlated response as the temperature of the Reid vapor pressure control system is high enough for the additional energy input to cause additional gas to be driven off and additional lighter hydrocarbons to be vaporized from the oil phase.

During a decremented energy input rate period 310, the process controller 130 decrements the energy input rate to a known decremented energy input rate 326 below the baseline energy input rate 328. As the Reid vapor pressure control system is in energy input regime B 206, the sensible heat flux at the incremented energy input rate 316 will not show a correlation with the decremented energy input rate 326 as the reduced energy input does not contribute to a drop in the sensible heat flux through the Reid vapor pressure control system. The gas flowrate at the decremented energy input rate 314 will show a correlated response as the temperature of the Reid vapor pressure control system is sufficient for the reduced energy input to cause less gas to be driven off and less lighter hydrocarbons to be vaporized from the oil phase.

FIG. 3C is an illustration of a response of a Reid vapor pressure control system 100 during a pulsed system disturbance test process while the Reid vapor pressure control system 100 is in an energy input regime C 208 in accordance with some examples. The illustration includes a graph of a gas flowrate 224, a sensible heat flux 204, and an energy input rate 302 versus elapsed time 304 for a pulsed energy input rate.

During a baseline energy input rate period 306, the process controller 130 holds energy input into the Reid vapor pressure control system at a known baseline energy input rate 328. At the baseline energy input rate 328, the Reid vapor pressure control system exhibits a baseline sensible heat flux 322 and baseline gas flowrate 320 through the Reid vapor pressure control system.

During an incremented energy input rate period 308, the process controller 130 increments the energy input rate to an incremented energy input rate 324. The Reid vapor pressure control system will exhibit a sensible heat flux at the incremented energy input rate 316 and a gas flowrate at the incremented energy input rate 312. As the Reid vapor pressure control system is in energy input regime C 208, the sensible heat flux at the incremented energy input rate 316 will show a correlated response with the incremented energy input rate 324 as any additional energy input contributes to the sensible heat flux through the Reid vapor pressure control system. The gas flowrate at the incremented energy input rate 312 will not exhibit a correlated response as the temperature of the Reid vapor pressure control system is already above a temperature at which additional energy input will cause additional gas to be driven off or additional lighter hydrocarbons to be vaporized from the oil phase.

During a decremented energy input rate period 310, the process controller 130 decrements the energy input rate to a known decremented energy input rate 326 below the baseline energy input rate 328. As the Reid vapor pressure control system is in energy input regime C 208, the sensible heat flux at the decremented energy input rate 318 will show a weak correlation with the incremented energy input rate 324 as the reduced energy input will cause the Reid vapor pressure control system to transition from energy input regime C 208 to energy input regime B 206 which contributes to a drop in the sensible heat flux through the Reid vapor pressure control system. The gas flowrate at the decremented energy input rate 314 will show a correlated response as the temperature of the Reid vapor pressure control system is now low enough for the reduced energy input to cause less gas to be driven off and less lighter hydrocarbons to be vaporized from the oil phase.

TABLE 1

| | | |
|---|---|---|
| In energy input | ΔQi > 0 → ΔQs > 0, | ΔQi < 0 → ΔQs < 0, |
| regime A 202 | ΔFg ≈ 0 | ΔFg ≈ 0 |
| In energy input | ΔQi > 0 → ΔQs ≈ 0, | ΔQi < 0 → ΔQs ≈ 0, |
| regime B 206 | ΔFg > 0 | ΔFg < 0 |
| In energy input | ΔQi > 0 → ΔQs > 0, | ΔQi < 0 → ΔQs < 0, |
| regime C 208 | ΔFg ≈ 0 | ΔFg < 0 |

Table 1 illustrates a summation of the exhibited behavior of the Reid vapor pressure control system during a pulsed system disturbance test. In the table, Qi represents an energy input rate, Qs represents a sensible heat flux, Fg represents gas phase flowrate, and Δ represents a change in the parameter. For example, when the Reid vapor pressure control system 100 is operating in energy input regime A 202, during an incremented energy input rate setpoint period, ΔQi>0, the change in sensible heat, ΔQs, is positive, or >0, and the change in gas phase flowrate, ΔFg, is approximately 0, or ≈0. As another example from the table, when the Reid vapor pressure control system is in energy input regime C 208, during a decremented energy input rate setpoint period, ΔQi<0, ΔQs is negative, or <0, and ΔFg, is negative, or <0.

The values from Table 1 can be used in conjunction with parameters of the Reid vapor pressure control system 100 determined during a pulsed system disturbance test to determine in what energy input regime the Reid vapor pressure control system 100 is operating in. For example, if: during an incremented energy input rate setpoint period, ΔQi >0, the change in sensible heat is determined to be positive, ΔQs>0, and the change in gas phase flowrate is determined to be approximately 0, ΔFg≈0; and during a decremented energy input rate period, the change in sensible heat is determined to be negative, ΔQs<0, and the change in gas phase flowrate is determined to be approximately 0, ΔFg≈0; then the Reid vapor pressure control system 100 can be determined to be in an energy input regime A.

In some examples, a statistical measure of a parameter measured during a baseline energy input rate period can be used to determine if the parameter is changing during an incremented energy input rate setpoint period or a decremented energy input rate period. The statistical measure may be used in an outlier test or may be used to set minimum and maximum limits. In some examples, the statistical measure is a standard deviation, and a change in a parameter is determined to be approximately 0 when the measured parameter during the decremented energy input rate period or incremented energy input rate setpoint period is within plus or minus a multiple of the standard deviation. In additional examples, a parameter of the Reid vapor pressure control system 100 can be determined to be increasing or decreasing during a decremented energy input rate period or incremented energy input rate setpoint period by the parameter's value increasing or decreasing by more than a multiple of the standard deviation.

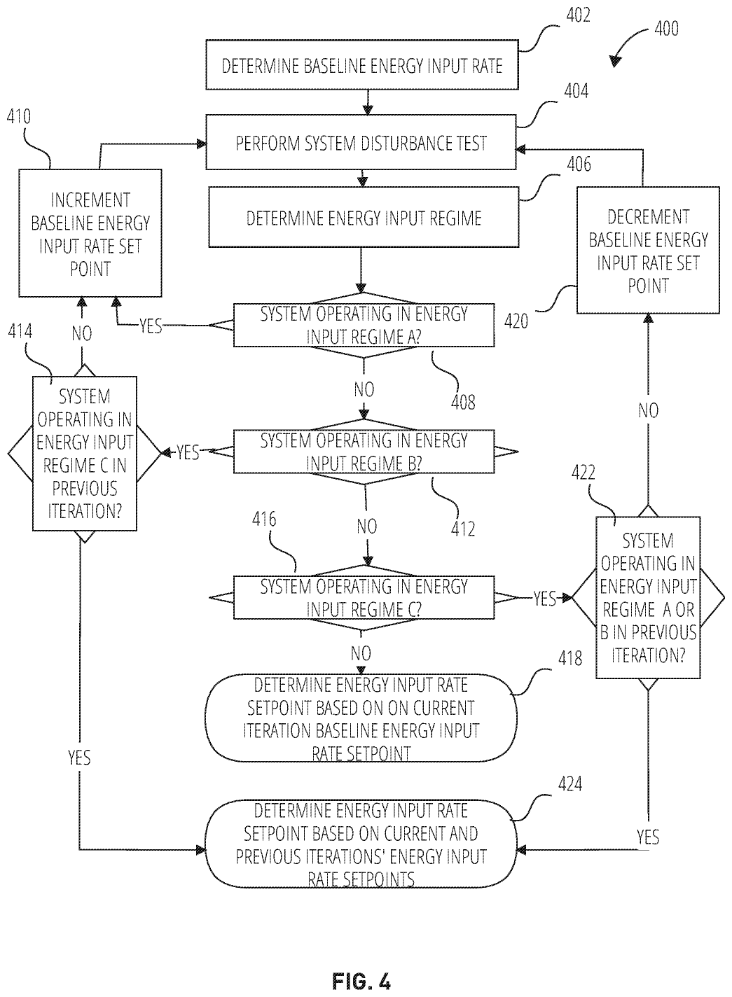

FIG. 4 is an activity diagram of an energy input rate determination process 400 for a Reid vapor pressure control system 100 in accordance with some examples. A process controller 130 of the Reid vapor pressure control system 100 uses the energy input rate determination process 400 to determine an energy input rate 226 for reducing the Reid vapor pressure of an oil phase 150 of a multiphase flow stream.

In operation 402, the process controller 130 determines a baseline energy input rate of the Reid vapor pressure control system 100. In some examples, the process controller 130 determines the baseline energy input rate setpoint from the current operating parameters of the energy input device 122 of the Reid vapor pressure control system 100.

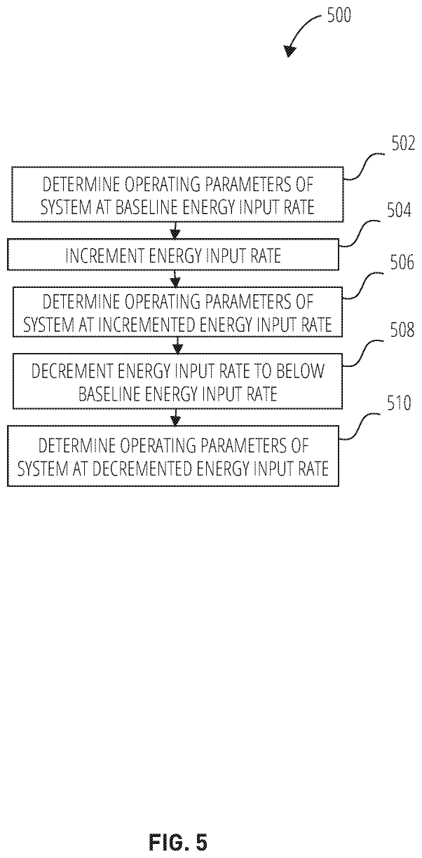

In operation 404, the process controller 130 starts an iteration of the energy input rate determination process 400 and performs a system disturbance test on the Reid vapor pressure control system 100 as described more fully reference to FIG. 5 and determines parameters of the Reid vapor pressure control system 100 during the system disturbance test.

In operation 406, the process controller 130 determines which energy input zone, energy input regime A 202, energy input regime B 206, or energy input regime C 208, the Reid. vapor pressure control system 100 is operating in based on the parameters of the Reid vapor pressure control system determined during the system disturbance test as described more fully in reference to FIG. 2, FIG. 3A, FIG. 3B, and FIG. 3C and Table 1.

In operation 408, on the basis of the process controller 130 determining that the Reid vapor pressure control system 100 system is operating in energy input regime A 202, the process controller 130 transitions to operation 410.

In operation 410, the process controller 130 increments the baseline energy input rate set point of the Reid vapor pressure control system 100 and transitions to operation 404 to perform another iteration of the energy input rate determination process 400.

In operation 408, on the basis of determining that the Reid vapor pressure control system 100 is not operating in energy input regime A 202, the process controller 130 transitions to operation 412.

In operation 412, on the basis of determining that the Reid vapor pressure control system 100 is operating in energy input regime B 206, the process controller 130 transitions to operation 414.

In operation 414, on the basis of determining that the Reid vapor pressure control system 100 was not operating in energy input regime C 208 in a previous iteration of the energy input rate determination process 400, the process controller 130 transitions to operation. 410, increments the baseline energy input rate set point of the Reid vapor pressure control system 100, and transitions to operation 404 to perform another iteration of the energy input rate determination process 400.

In operation 414, on the basis of determining that the Reid vapor pressure control system 100 was operating in energy input regime C 208 in a previous iteration of the energy input rate determination process 400, the process controller 130 transitions to operation 424.

In operation 424, the process controller 130 determines the energy input rate setpoint based on the current baseline energy input rate setpoint of the current iteration of the energy input rate determination process 400 and a previous iteration baseline energy input rate setpoint of a previous iteration of the energy input rate determination process 400. In some examples, the process controller 130 averages the current baseline energy input rate setpoint and a previous iteration baseline energy input rate setpoint to determine the energy input rate setpoint.

In operation 412, on the basis of determining that the Reid vapor pressure control system 100 is not operating in energy input regime B 206, the process controller 130 transitions to operation 416.

In operation 416, on the basis of determining that the Reid vapor pressure control system 100 is operating in energy input regime C 208, the process controller 130 transitions to operation 422.

In operation 422, on the basis of determining that the Reid vapor pressure control system 100 was operating in energy input regime A 202 or energy input regime B 206 in a previous iteration, the process controller 130 transitions to operation 424 and determines an energy input rate setpoint based on the current baseline energy input rate setpoint of the current iteration of the energy input rate determination process 400 and a previous iteration baseline energy input rate setpoint of a previous iteration of the energy input rate determination process 400.

In operation 422, on the basis of determining that the Reid vapor pressure control system 100 was not operating in energy input regime A 202 or energy input regime B 206 in a previous iteration, the process controller 130 transitions to operation 420.

In operation 420, the process controller 130 decrements the baseline energy input rate set point and transitions to operation 404 to begin another iteration of the energy input rate determination process 400.

In operation 416, on the basis of determining that the Reid vapor pressure control system 100 is not operating in energy input regime C 208, the process controller 130 transitions to operation 418.

In operation 418 the process controller 130 determines the energy input rate setpoint based on the current iteration's baseline energy input rate setpoint. For example, the process controller 130 simply sets the energy input rate 226 as the current iterations baseline energy input rate.

In some examples, an energy input rate is specified in units of a unit of energy input per unit of mass input, Qᵢ/mᵢ, and a flowrate of an input multiphase flow stream is determined in units of a unit of mass input per unit of time, mᵢ/t. During operation of the Reid vapor pressure control system 100, a desired operational energy input rate can be determined by a product of the energy input rate by a mass input, or Qᵢ/mᵢ×mᵢ/t=Qᵢ/t.

In some examples, the process controller 130 determines the Reid vapor pressure control system 100 as operating in energy input regime A 202, energy input regime B 206, or energy input regime C 208 using artificial intelligence methodologies and an energy input zone model previously generated using machine learning methodologies. In some examples, the energy input zone model may comprise, but is not limited to, a neural network, a learning vector quantization network, a logistic regression model, a support vector machine, a random decision forest, a naive Bayes model, a linear discriminant analysis model, and a K-nearest neighbor model. In some examples, machine learning methodologies may include, but are not limited to, supervised learning, unsupervised learning, semi-supervised learning, reinforcement learning, dimensionality reduction, self-learning, feature learning, sparse dictionary learning, and anomaly detection.

FIG. 5 is an activity diagram of a system disturbance test process 500 performed by a process controller 130 of a Reid vapor pressure control system 100 in accordance with some examples. The process controller 130 uses the system disturbance test process 500 to perform a pulsed system disturbance test as more fully described with reference to FIG. 3A, FIG. 3B, and FIG. 3C.

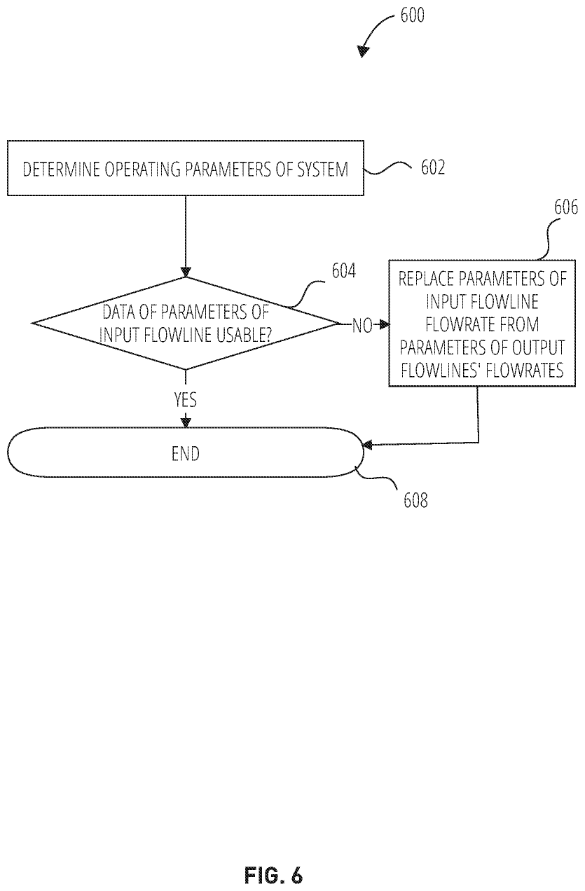

In operation 502, the process controller 130 determines operating parameters of the Reid vapor pressure control system 100 at a baseline energy input rate 328 during a baseline energy input rate period 306 as more fully described with reference to FIG. 6.

In operation 504, the process controller 130 increments the energy input rate of the Reid vapor pressure control system 100 to an incremented energy input rate 324.

In operation 506, the process controller 130 determines operating parameters of the Reid vapor pressure control system 100 at the incremented energy input rate 324 for an incremented energy input rate period 308.

In operation 508, decrements the energy input rate to a decremented energy input rate 326 below the baseline energy input rate 328.

In operation 510, the process controller 130 determines operating parameters of the Reid vapor pressure control system 100 at the decremented energy input rate 326 for a decremented energy input rate period 310.

In some examples, the operating parameters of the Reid vapor pressure control system 100 include an internal temperature of the separator vessel 102 as measured by and a separator vessel temperature sensor 158 and an amount of energy in the form of heat lost from the separator vessel 102 to the environment as measured by a separator vessel energy flux sensor 154.

FIG. 6 is an activity diagram of an operating parameters determination process 600 of a Reid vapor pressure control system 100 in accordance with some examples. A process controller 130 of the Reid vapor pressure control system 100 uses the operating parameters determination process 600 to determine operating parameters of the Reid vapor pressure control system 100.

In operation 602, the process controller 30 determines the operating parameters of the Reid vapor pressure control system 100.

In some examples, the operating parameters of the Reid vapor pressure control system 100 include parameters of an output gas phase of the input multiphase flow stream including an output gas phase flowrate as measured by a gas flowrate sensor 140, an output gas phase pressure as measured by a gas flow pressure sensor 142, and an output gas phase temperature as measured by a gas flow temperature sensor 144.

In some examples, the operating parameters of the Reid vapor pressure control system 100 include parameters of an output water phase of the input multiphase flow stream including an output water phase flowrate as measured by a water flowrate sensor 134, and an output water phase temperature as measured by a water flow temperature sensor 132.

In some examples, the operating parameters of the Reid vapor pressure control system 100 include parameters of an output oil phase of the input multiphase fl ow stream including an output oil phase flowrate as measured by an oil flowrate sensor 136, and an output oil phase temperature as measured by an oil flow temperature sensor 138.

In some examples, the operating parameters of the Reid vapor pressure control system 100 include an energy input rate of the energy input device 122.

In some examples, the operating parameters of the Reid vapor pressure control system include a mass flowrate for each of the fluid phases in the multiphase flow stream. For the gas phase, a mass flowrate can be determined based on a volumetric flowrate of the gas phase, a temperature of the gas phase, a pressure of the gas phase, and a composition of the gas phase. For the oil phase, a mass flowrate can be determined based on a volumetric flowrate of the oil phase, a temperature of the oil phase, and an API gravity of the oil phase at standard conditions. For the water phase, a mass flowrate can be determined based on a volumetric flowrate of the water phase, a temperature of the water phase, and a specific gravity of the water phase at standard conditions.

In some examples, the operating parameters of the Reid vapor pressure control system 100 include parameters of an input multiphase flow stream including an input multiphase flow stream flowrate as measured by a multiphase flow stream flowrate sensor 128, an input multiphase flow stream pressure as measured by a multiphase flow stream pressure sensor 124, and an input multiphase flow stream temperature as measured by a multiphase flow stream temperature sensor 126.

The multiphase flow stream may contain oil, water, and gas at various fractions that change over time. This causes the flow regime of the multiphase flow stream to change over time as well. For example, at a low gas fraction, the flow regime of the multiphase flow stream may resemble bubble flow where the gas phase of the multiphase flow stream is entrained as various sized bubbles of within a continuous liquid phase the combined oil and water phases of the multiphase flow stream. At a moderate gas fraction, the flow regime of the multiphase flow stream may resemble slug flow where slugs of gas are interspersed with slugs of liquid. At a high gas fraction, the flow regime of the multiphase flow stream may resemble mist flow where the oil and water phases are dispersed in a fine mist within a continuous gas phase.

These different flow regimes affect different types of flowmeters differently. Some flowmeters may be able to measure flowrates in multiphase flow streams when the relative fractions of the oil, water, and gas are known so long as there is a continuous phase. Many flowmeters fail to measure multiphase flow stream flowrates accurately in slug flow conditions. Therefore, the process controller 130 determines if the data of input multiphase flow stream flowrate parameters is usable on the basis of analyzing the data of the parameters of the multiphase flow stream flowrate. In some examples, in a slug flow regime, the data of the parameters of the multiphase flow stream flowrate may fluctuate wildly causing a flowmeters response to become over-limited or under-limited. In some examples, a magnetic flowmeter performs self-diagnostics and responds with an error condition code when the flowmeter determines that the flowmeter is incapable of measuring a flowrate of the multiphase flow stream because the multiphase flow stream does not possess sufficient conductivity to determine an accurate flowrate. Therefore, the process controller 130 may analyze data of the parameters of the multiphase flow stream flowrate and determine that the data of the parameters of the flowrate are unusable when the process controller 130 detects an over-limited flowmeter response, an under-limited flowmeter response, an error condition, a wide variance in the measured flowrate, etc.

In operation 604, on the basis of determining that the data of the parameters of the multiphase flow stream flowrate are unusable, the process controller 130 transitions to operation 606.

In operation 606, the process controller 130 replaces the parameters of the input multiphase flow stream flowrate with the parameters of the output flowrates and then transitions to operation 608.

In operation 604, on the basis of determining that the data of the parameters of the multiphase flow stream flowrate are usable, the process controller 130 transitions to operation 608.

In operation 608, the process controller 130 ends the operating parameters determination process 600.

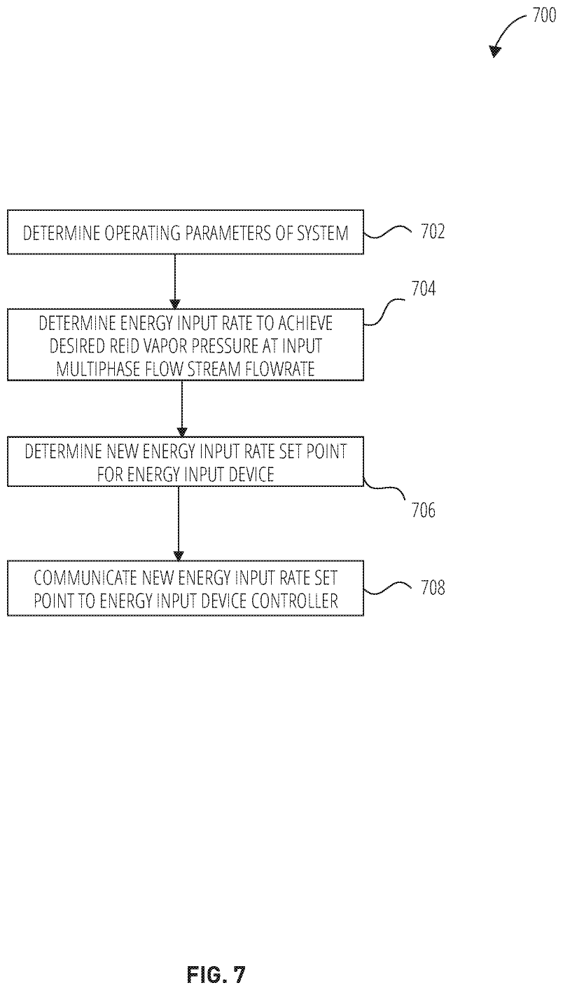

FIG. 7 is an activity diagram of a Reid vapor pressure control system 100 during a Reid vapor pressure reduction process 700 in accordance with some examples. A process controller 130 of the Reid vapor pressure control system 100 uses the Reid vapor pressure reduction process 700 to operate the Reid vapor pressure control system 100 and reduce a Reid vapor pressure of an oil phase 150 of a multiphase flow stream.

During the Reid vapor pressure reduction process 700, a multiphase flow stream including a mixture of crude oil, produced water, and produced gas enters the separator vessel 102 via the inlet flowline 104. In operation 702, the process controller 130 determines the operating parameters of the Reid vapor pressure control system 100 as more fully described with reference to FIG. 6.

In operation 704, the process controller 130 determines an energy input rate to achieve a desired Reid vapor pressure at the input multiphase flow stream flowrate based on a previously calculated energy input rate and the parameters of the Reid vapor pressure control system 100.

In operation 706, the process controller 130 determines an energy input rate setpoint for the energy input device 122 based on the energy input rate and a type of energy input device 122 utilized by the Reid vapor pressure control system 100. In some examples, when the energy input device 122 is a gas-operated heater, the 130 determines a feed gas flowrate for the gas-operated heater based on the energy input rate, a temperature of the feed gas as measured using a gas feed temperature sensor 116, a pressure of the feed gas as measured by a gas feed pressure sensor 118, a density of the feed gas, and a heat content of the feed gas. In some examples, when the energy input device 122 is an electrically operated heater, the process controller 130 determines an amount of electrical power to be provided to the energy input device 122.

In operation 708, the process controller 130 communicates the energy input rate setpoint to an energy input device controller that controls the final control element of energy input device 122. In some examples, when the energy input device 122 is gas-fired, the energy input rate controller is a valve controller and the final control element is a feed gas control valve. In some examples, when the energy input device 122 is electrically powered, the energy input rate controller is a time proportioning controller and the final control element is a solid-state contactor.

In response to receiving the energy input rate setpoint, the energy input device controller controls energy input device 122 to provide energy input at the setpoint rate to the separator vessel 102. The separator vessel 102 separates the oil, water, and gas into the oil phase 150, the water phase 152, and the gas phase 148. The energy input into the separator vessel 102 causes entrained gas to be driven from the oil phase 150 and light hydrocarbons to be vaporized from the oil phase 150 into the gas phase 148. The gas phase 148 exits the separator vessel 102 via the gas output flowline 110, the water phase 152 exits the separator vessel 102 via the water flowline 106, and the oil phase 150 exits the separator vessel 102 via the oil output flowline 108. As gases and light hydrocarbons are removed from the entering oil phase, the exiting oil phase has a lower Reid vapor pressure than the entering oil phase.

In some examples, the Reid vapor pressure control system 100 is used for an additional purpose, such as emulsion breaking that may involve operating the Reid vapor pressure control system 100 at a specified temperature other than a temperature that the Reid vapor pressure control system 100 equilibrates at when the process controller 130 is supplying, via the energy input device 122, an energy input rate 326. In such examples, in operation 704, the process controller 130 further determines if the Reid vapor pressure control system 100 is operating below, at, or above the specified temperature. On a basis of determining that the Reid vapor pressure control system 100 is operating below the specified temperature, the process controller 130 adjusts the energy input rate of the Reid vapor pressure control system 100 based on the temperature of the Reid vapor pressure control system 100 and the specified temperature so as to raise the temperature of the Reid vapor pressure control system 100. On a basis of determining that the Reid vapor pressure control system 100 is operating at or above the specified temperature, the process controller 130 determines the energy input rate to achieve the desired Reid vapor pressure at the input multiphase flow stream flowrate based on the previously calculated energy input rate and the parameters of the Reid vapor pressure control system 100.

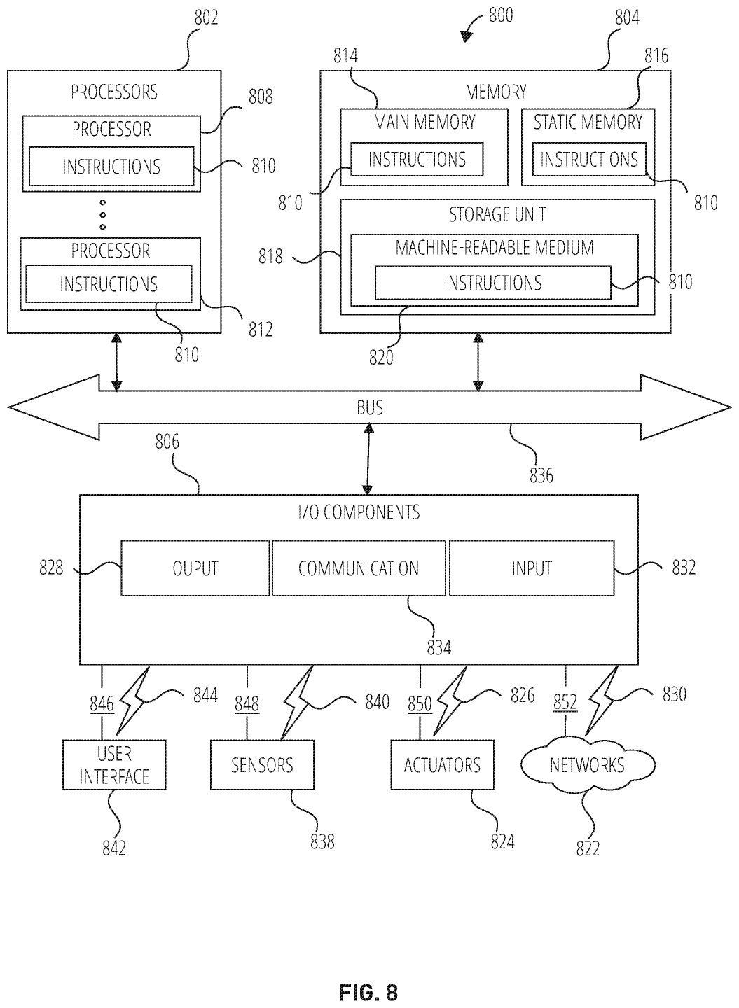

FIG. 8 is a diagrammatic representation of a computing apparatus 800 within which instructions 810 (e.g., software, a program, an application, an applet, an app, or other executable code) for causing the computing apparatus 800 to perform any one or more of the methodologies discussed herein may be executed. The computing apparatus 800 may be utilized as a process controller 130 of FIG. 1A. For example, the instructions 810 may cause the computing apparatus 800 to execute any one or more of the methods described herein. The instructions 810 transform the general, non-programmed computing apparatus 800 into a particular computing apparatus 800 programmed to carry out the described and illustrated functions in the manner described.

The computing apparatus 800 may operate as a standalone device or may be coupled (e.g., networked) to other machines. In a networked deployment, the computing apparatus 800 may operate in the capacity of a server machine or a client machine in a server-client network environment, or as a peer device in a peer-to-peer (or distributed) network environment. The computing apparatus 800 may comprise, but is not limited to, a server computer, a client computer, a programmable logic controller, a process controller, a personal computer (PC), a tablet computer, a laptop computer, a netbook, a cellular telephone, a smart phone, a mobile device, a web appliance, a network router, a network switch, a network bridge, or any, computing apparatus capable of executing the instructions 810, sequentially or otherwise, that specify actions to be taken by the computing apparatus 800. Further, while a single computing apparatus 800 is illustrated, the term “computing apparatus” may also be taken to include a collection of computing apparatuses that individually or jointly execute the instructions 810 to perform any one or more of the methodologies discussed herein.

The computing apparatus 800 may include processors 802, memory 804, and I/O components 806, which may be configured to communicate with one another via a bus 836. In some examples, the processors 802 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 808 and a processor 812 that execute the instructions 810. The term “processor” is intended to include multi-core processors that may comprise two or more independent processors (sometimes referred to as “cores”) that may execute instructions contemporaneously. Although FIG. 8 shows multiple processors 802, the computing apparatus 800 may include a single processor with a single core, a single processor with multiple cores (e.g., a multi-core processor), multiple processors with a single core, multiple processors with multiples cores, or any combination thereof.

The memory 804 includes a main memory 814, a static memory 816, and a storage unit 818, both accessible to the processors 802 via the bus 836. The main memory 804, the static memory 816, and storage unit 818 store the instructions 810 embodying any one or more of the methodologies or—functions described herein. The instructions 810 may also reside, completely or partially, within the main memory 814, within the static memory 816, within machine-readable medium 820 within the storage unit 818, within one or more of the processors 802 (e.g., within the processor's cache memory), or any suitable combination thereof, during execution thereof by the computing apparatus 800.

The I/O components 806 may include a wide variety of interface components to receive user input, provide control outputs, communicate information, capture measurements, and so on. The specific I/O components 806 that are included in a particular computing apparatus will depend on the type of computing apparatus. For example, a controller may include an interface to a touch input device or other such input mechanisms, while a headless server machine will likely not include such a touch input device. It will be appreciated that the I/O components 806 may include many other components that are not shown in FIG. 8.

In various examples, the I/O components 806 may include output interface components 828, communication interface components 834, and input interface components 832. The input interface components 832, output interface components 828 and communication interface components 834 may provide coupling to one or more user interfaces 842. The coupling may be wired 846 or wireless 844. Output components used for the one or more user interfaces 842 may include displays (e.g., plasma display panels (PDP), light emitting diode (LED) displays, liquid crystal displays (LCD), projectors, or cathode ray tubes (CRT)), acoustic components (e.g., speakers), haptic components (e.g., a vibratory motor, resistance mechanisms), annunciators, other signal generators, and so forth. Input components for the one or more user interfaces 842 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

The input interface components 832 and communication interface components 834 may provide coupling to one or more sensors 838. The coupling may be wired 848 or wireless 840. The one or more sensors 838 transduce process variables (e.g., pressure, flow, temperature, mass, position, level, etc.) into sensor signals that are communicated to the computing apparatus 800.

The output interface components 828 and communication interface components 834 may provide coupling to one or more actuators 824. The coupling may be wired 850 or wireless 826. The one or more actuators 824 receive control signals from the computing apparatus 800 and actuate and/or control one or more respective final control elements (e.g., valves, dampers, switches, pumps, fans, conveyer systems, loaders, etc.) based on the control signals.

The I/O components 806 may communicate with the actuators 824 and sensors 838 using digital communication protocols (e.g., AS-i, BSAP, CC-Link Industrial Networks, CIP, CAN bus, ControlNet, DeviceNet, DF-I protocol, DirectNet, EtherCAT, EGD, EtherNet/IP, Ethernet Powerlink, FINS, FOUNDATION fieldbus, HART Protocol, HostLink Protocol, Interbus, MACRO Fieldbus, MECHATROLINK, MelsecNet, Modbus PEMEX, OSGP, Optomux, PieP, Profibus, PROFINET IO, RAPIEnet, Honeywell SDS, SERCOS interface, SERCOS III, SSCNET, GE SRTP, Sinec H1, SynqNet, TTEthernet, MPI, and the like), analog transducer signal and control protocols (e.g., 4-20 mA, 0-10V, or the like) or binary protocols.

The communication interface components 834 may provide coupling to one or more networks 822. The coupling may be wired 852 or wireless 830. Communications may be implemented using a wide variety of technologies. For example, the communication interface components 834 may include a network interface component or another suitable device to interface with the networks 822. In further examples, the communication interface components 834 may include wired communication components, wireless communication components, cellular communication components, Near Field Communication (NFC) components, Bluetooth® components (e.g., Bluetooth® ® Low Energy), Wi-Fi® components, and other communication components to provide communication via other modalities.

Moreover, the communication interface components 834 may detect identifiers or include components operable to detect identifiers. For example, the communication interface components 834 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication interface components 834, such as location via Internet Protocol (IP) geolocation, location via Wi-Fi® signal triangulation, location via detecting an NFC beacon signal that may indicate a particular location, and so forth.

The various memories (e.g., memory 804, main memory 814, static memory 816, and/or memory of the processors 802) and/or storage unit 818 may store one or more sets of instructions and data structures (e.g., software) embodying or used by any one or more of the methodologies or functions described herein. These instructions (e.g., the instructions 810), when executed by processors 802, cause various operations to implement the disclosed examples.

The instructions 810 may be transmitted or received over the networks 822, using a transmission medium, via a network interface device (e.g., a network interface component included in the communication interface components 834) and using any one of a number of well-known transfer protocols (e.g., hypertext transfer protocol (HTTP)). Similarly, the instructions 810 may be transmitted or received using a transmission medium via the wireless 826 (e.g., a peer-to-peer coupling) to the actuators 824.

Various examples of the present disclosure may be described herein with reference to flowchart illustrations and/or block diagrams of methods, apparatus (systems), and computer program products. Although a flowchart or block diagram may illustrate a method as comprising sequential steps or a process as having a particular order of operations, many of the steps or operations in the flowchart/s) or block diagram(s) illustrated herein can be performed in parallel or concurrently, and the flowchart(s) or block diagram(s) should be read in the context of the various examples of the present disclosure. In addition, the order of the method steps or process operations illustrated in a flowchart or block diagram may be rearranged for some examples. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, example, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(1) unless the words “means for” or “step for” are explicitly used in the particular claim.

Additionally, as used herein, the phrase “at least one of [X] and [Y],” where X and Y are different components that may be included in an example of the present disclosure, means that the example could include component X without component Y, the example could include the component Y without component X, or the example could include both components X and Y. Similarly, when used with respect to three or more components, such as “at least one of [X], [Y], and [Z],” the phrase means that the example could include any one of the three or more components, any combination or sub-combination of any of the components, or all of the components.

In the foregoing description various examples of the present disclosure have been presented for the purpose of illustration and description. They are not intended to be exhaustive or limiting to the precise form disclosed. Obvious modifications or variations are possible in light of the above teachings. The various examples were chosen and described to provide the best illustration of the principals of the disclosure and their practical application, and to enable one of ordinary skill in the art to utilize the various examples with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A Reid vapor pressure control system, comprising:
a separator vessel;
an energy input device operably connected to the separator vessel;
a gas flowrate sensor operably connected to the separator vessel;
one or more liquid flowrate sensors operably connected to the separator vessel;
one or more liquid flow temperature sensors; and
a process controller operably connected to the energy input device, the gas flowrate sensor, the one or more liquid flowrate sensors, and the one or more liquid flow temperature sensors, the process controller comprising:
one or more processors; and
a memory storing processor executable instructions that, when executed by the one or more processors, cause the process controller to perform operations of:
determining an energy input rate to reduce a Reid vapor pressure of an of an oil phase of a multiphase flow stream being processed by the Reid vapor pressure control system using the gas flowrate sensor, the one or more liquid flowrate sensors, and the one or more liquid flow temperature sensors; and
controlling the energy input device to input energy into the separator vessel at the energy input rate.

2. The Reid vapor pressure control system of claim 1, wherein the instructions that, when executed by the one or more processors, cause the process controller to perform operations of determining the energy input rate further cause the process controller to perform operations comprising:
performing a system disturbance test of the Reid vapor pressure control system;
determining operating parameters of the Reid vapor pressure control system during the system disturbance test using the gas flowrate sensor, the one or more liquid flowrate sensors, and the one or more liquid flow temperature sensors; and
determining the energy input rate based on the operating parameters of the Reid vapor pressure control system.

3. The Reid vapor pressure control system of claim 2, wherein the instructions that, when executed by the one or more processors, cause the process controller to perform operations of performing a system disturbance test of the Reid vapor pressure control system, further cause the process controller to perform operations comprising:
determining operating parameters of the Reid vapor pressure control system at a baseline energy input rate during a baseline energy input rate period using the gas flowrate sensor, the one or more liquid flowrate sensors, and the one or more liquid flow temperature sensors;
incrementing an energy input rate to an incremented energy input rate; and
determining operating parameters of the Reid vapor pressure control system at the incremented energy input rate for an incremented energy input rate period using the gas flowrate sensor, the one or more liquid flowrate sensors, and the one or more liquid flow temperature sensors.

4. The Reid vapor pressure control system of claim 3, wherein the instructions that, when executed by the one or more processors, cause the process controller to perform operations of performing the system disturbance test of the Reid vapor pressure control system, further cause the process controller to perform operations comprising:
decrementing the energy input rate to a decremented energy input rate; and
determining operating parameters of the Reid vapor pressure control system at the decremented energy input rate for a decremented energy input rate period using the gas flowrate sensor, the one or more liquid flowrate sensors; and the one or more liquid flow temperature sensors.

5. The Reid vapor pressure control system of claim 2; wherein the instructions that; when executed by the one or more processors, cause the process controller to perform operations of determining the energy input rate, further cause the process controller to perform operations comprising:
determining a change in a sensible heat flux of the Reid vapor pressure control system using the one or more liquid flowrate sensors, the one or more liquid flow temperature sensors, and the gas flowrate sensor;
determining a change in a gas flowrate of a gas phase of the multiphase flow stream using the gas flowrate sensor; and
determining an energy input regime of the Reid vapor pressure control system based on the change in sensible heat flux and the change in the gas flowrate of the gas phase of the multiphase flow stream.

6. The Reid vapor pressure control system of claim 1, wherein
the Reid vapor pressure control system further comprises a heat flux sensor that senses an energy flux from the separator vessel, and
wherein the instructions that, when executed by the one or more processors, cause the process controller to perform operations of determining the energy input rate further cause the process controller to use the heat flux sensor to determine the energy flux out of the separator vessel to a surrounding environment.

7. The Reid vapor pressure control system of claim 1, wherein the one or more liquid flowrate sensors include an oil flowrate sensor and a water flowrate sensor.

8. A method of operating a Reid vapor pressure control system, the method comprising:
determining, by one or more processors, an energy input rate to reduce a Reid vapor pressure of an oil phase of a multiphase flow stream being processed by the Reid vapor pressure control system in a separator vessel using a gas flowrate sensor, one or more liquid flowrate sensors, and one or more liquid flow temperature sensors of the Reid vapor pressure control system; and
controlling, by the one or more processors, an energy input device to input energy into the separator vessel of the Reid vapor pressure control system at the energy input rate.

9. The method of operating the Reid vapor pressure control system of claim 8, wherein determining the energy input rate further comprises:
performing a system disturbance test of the Reid vapor pressure control system;
determining operating parameters of the Reid vapor pressure control system during the system disturbance test using the gas flowrate sensor, the one or more liquid flowrate sensors, and the one or more liquid flow temperature sensors; and
determining the energy input rate based on the operating parameters of the Reid vapor pressure control system.

10. The method of operating the Reid vapor pressure control system of claim 9, wherein performing the system disturbance test of the Reid vapor pressure control system further comprises:
determining operating parameters of the Reid vapor pressure control system at a baseline energy input rate during a baseline energy input rate period using the gas flowrate sensor, the one or more liquid flowrate sensors, and the one or more liquid flow temperature sensors;
incrementing an energy input rate to an incremented energy input rate; and
determining operating parameters of the Reid vapor pressure control system at the incremented energy input rate for an incremented energy input rate period using the gas flowrate sensor, the one or more liquid flowrate sensors, and the one or more liquid flow temperature sensors.

11. The method of operating the Reid vapor pressure control system of claim 10, wherein performing the system disturbance test of the Reid vapor pressure control system further comprises:
decrementing the energy input rate to a decremented energy input rate; and
determining operating parameters of the Reid vapor pressure control system at the decremented energy input rate for a decremented energy input rate period using the gas flowrate sensor, the one or more liquid flowrate sensors, and the one or more liquid flow temperature sensors.

12. The method of operating the Reid vapor pressure control system of claim 9, wherein determining the energy input rate further comprises:
determining a change in a sensible heat flux of the Reid vapor pressure control system using the one or more liquid flowrate sensors, the one or more liquid flow temperature sensors, and the gas flowrate sensor;
determining a change in a gas flowrate of a gas phase of the multiphase flow stream using the gas flowrate sensor; and
determining an energy input regime of the Reid vapor pressure control system based on the change in sensible heat flux and the change in the gas flowrate of the gas phase of the multiphase flow stream.

13. The method of operating the Reid vapor pressure control system of claim 8, wherein determining the energy input rate further comprises using a heat flux sensor to determine an energy flux out of the separator vessel to a surrounding environment.

14. The method of operating the Reid vapor pressure control system of claim 8, wherein the one or more liquid flowrate sensors include an oil flowrate sensor and a water flowrate sensor.

15. A non-transitory computer-readable storage medium, the computer-readable storage medium including instructions that, when executed by one or more processors, cause a computing apparatus to perform operations comprising:
determining an energy input rate to reduce a Reid vapor pressure of an oil phase of a multiphase flow stream being processed by a Reid vapor pressure control system in a separator vessel using a gas flowrate sensor, one or more liquid flowrate sensors, and one or more liquid flow temperature sensors of the Reid vapor pressure control system; and
controlling an energy input device to input energy into the separator vessel of the Reid vapor pressure control system at the energy input rate.

16. The computer-readable storage medium of claim 15, wherein the instructions that, when executed by one or more processors, cause the computing apparatus to perform operations of determining the energy input rate further cause the computing apparatus to perform operations comprising:
performing a system disturbance test of the Reid vapor pressure control system;
determining operating parameters of the Reid vapor pressure control system during the system disturbance test using the gas flowrate sensor, the one or more liquid flowrate sensors, and the one or more liquid flow temperature sensors; and
determining the energy input rate based on the operating parameters of the Reid vapor pressure control system.

17. The computer-readable storage medium of claim 16, wherein the instructions that, when executed by one or more processors, cause the computing apparatus to perform operations of performing the system disturbance test of the Reid vapor pressure control system further cause the computing apparatus to perform operations comprising:
determining operating parameters of the Reid vapor pressure control system at a baseline energy input rate during a baseline energy input rate period using the gas flowrate sensor, the one or more liquid flowrate sensors, and the one or more liquid flow temperature sensors;
incrementing an energy input rate to an incremented energy input rate; and
determining operating parameters of the Reid vapor pressure control system at the incremented energy input rate for an incremented energy input rate period using the gas flowrate sensor, the one or more liquid flowrate sensors, and the one or more liquid flow temperature sensors.

18. The computer-readable storage medium of claim 17, wherein the instructions that, when executed by one or more processors, cause the computing apparatus to perform operations of performing the system disturbance test of the Reid vapor pressure control system further cause the computing apparatus to perform operations comprising:
decrementing the energy input rate to a decremented energy input rate; and
determine operating parameters of the Reid vapor pressure control system at the decremented energy input rate for a decremented energy input rate period using the gas flowrate sensor, the one or more liquid flowrate sensors, and the one or more liquid flow temperature sensors.

19. The computer-readable storage medium of claim 16, wherein the instructions that, when executed by one or more processors, cause the computing apparatus to perform operations of determining the energy input rate further cause the computing apparatus to perform operations comprising:
determining a change in a sensible heat flux of the Reid vapor pressure control system using the one or more liquid flowrate sensors, the one or more liquid flow temperature sensors, and the gas flowrate sensor;
determining a change in a gas flowrate of a gas phase of the multiphase flow stream using the gas flowrate sensor; and
determining an energy input regime of the Reid vapor pressure control system based on the change in sensible heat flux and the change in the gas flowrate of the gas phase of the multiphase flow stream.

20. The computer-readable storage medium of claim 15, wherein the instructions that, when executed by one or more processors, cause the computing apparatus to perform operations of determining the energy input rate further cause the computing apparatus to perform operations comprising: using a heat flux sensor to determine an energy flux out of the separator vessel to a surrounding environment.

21. The computer-readable storage medium of claim 15, wherein the one or more liquid flowrate sensors include an oil flowrate sensor and a water flowrate sensor.
